(19) United States
(12) Patent Application Publication
(10) Pub. No.: US 2008/0290054 A1
(43) Pub. Date: Nov. 27, 2008

(54) Utensil storage stand

(76) Inventors: David Lee Cass, Greensburg, PA (US); Marilyn Kathryn Cass, (US)

Correspondence Address: Lawrence R. Burns, Esquire, 310 Coulter Building, 231 S. Main Street, Greensburg, PA, 15601, US

(21) Appl. No.: 11/805,111

(22) Filed: May 22, 2007

(51) Int. Cl. A47J 47/00

(52) U.S. Cl. 211/70

(57) ABSTRACT

This invention has to do with a utensil storage stand, which comprises a preferably planar base, a column extending away from the base, and a distal end on the column, with utensil engaging means comprising radially extending spokes with support hooks for engaging utensils stored on the stand. The distal end with hooked spokes is rotatably mounted with respect to an axis substantially perpendicular to the plane of the base. The radial support spokes preferably have support apertures and hooks so that utensils may be stored and efficiently positioned on the storage stand.

### BACKGROUND OF THE INVENTION

Preparation of food in the kitchen sometimes is a quite complex affair requiring many pots, pans and kitchen utensils. Pots and pans are usually stored out of sight in the kitchen area and a majority of utensils may be stored in a drawer that is convenient to the food preparation area. Utensils may also be stored on a countertop that is near and convenient to the food preparation area. When it is desired to follow a recipe, the sequential use of many cooking utensils and even the repeated use of the same utensil may be required, in which case it would be desirable to have a nearby and convenient place to store multiple utensils.

Typically some form of open topped canister may be used to store numerous utensils on a countertop with no organization to the assembly of utensils that are accumulated in the canister. The open topped canister has the drawback of trapping and collecting dust and debris through its open top while also having the further disadvantage that the utensils may become tangled with one another and not easily withdrawn from the canister. In addition if utensils are placed in the canister just after being washed they may drip some moisture into the bottom of the canister where it can accumulate and create unhealthy conditions. Limited space on a countertop also limits the use of canisters because the utensils in the back of the canister are not easily accessible with the utensils in the front of the canister blocking an easy reach to the rear of the canister. The canister or area that is usually available for the storage of utensils may be typically below the kitchen cabinets thereby limiting the space above the canister that is available to reach the utensils in the rear of the canister.

Many utensils used in the kitchen have perforations in their handles that are there for the purpose of hanging the utensils when not in use. Putting these utensils in drawers or upside down in canisters does not utilize the perforations as originally intended by the manufacturer.

### BRIEF SUMMARY OF THE INVENTION

The invention comprises a utensil storage stand having a preferably planar support base, a central column extending away from said support base, and utensil engagement means located on the distal end of the column with the capability for rotating the utensil engagement means with respect to an axis substantially perpendicular to the plane of the support base. The utensil engagement means on the utensil support stand will preferably be spokes extending radially away from the central column with utensil engagement means located along the spokes and at the distal ends of the spokes. Preferably the utensil engagement means will comprise a perforation formed through the radially extending spoke and even more preferably the utensil engagement means will comprise a perforation located along the length of the spoke with an upwardly facing hooks with outward ends extending outwardly from the spokes. The perforations will be spaced along the spokes and sized so as to allow utensil handles to pass therethrough for storage on the utensil storage stand. The upwardly facing hooks are preferably formed as pegs on the periphery of the perforations, with the hooks having upwardly turned ends on the pegs. Preferably there will also be pegs with upturned ends located between the column and the perforation where the central axis of the pegs form an acute angle of acute angle of 56 degrees plus or minus 5 degrees with the central longitudinal axis of the spokes. The utility engagement means located at a spaced distance from the support base may also be comprised of a polygonally sided disc with the spokes radially extending from the outer periphery of the polygonally sided disc. The perforations for holding the utensil handles are then formed in the polygonally sided disc.

### BRIEF DESCRIPTION OF THE DRAWINGS

FIG. 1 is a perspective view of the utensil storage stand according to the present invention.

FIG. 2 is a top view of the utensil storage stand according to the present invention.

FIG. 3 is a side view of the utensil storage stand according to the present invention.

FIG. 4 is a sectional view 44 through FIG. 2 of the utensil storage stand according to the present invention.

FIG. 5 is a sectional view 5-5 through FIG. 3 of the utensil storage stand according to the present invention.

FIG. 6 is an alternate embodiment of the utensil stand according to the present invention.

FIG. 7 is a top view of the alternate embodiment of the utensil stand according to the present invention.

FIG. 8 is a side view of the alternate embodiment of the utensil stand according to the present invention.

FIG. 9 is a sectional view 9-9 through FIG. 7 of the alternate embodiment according to the present invention.

FIG. 10 is a sectional view 10-10 through FIG. 8 of the alternate embodiment according to the present invention.

### OBJECTS OF THE INVENTION

It is an object of the present invention to provide convenient storage facility for kitchen utensils.

It is an object of the present invention to organize kitchen utensils on a convenient countertop location.

It is an object of the present invention to provide a kitchen utensil stand that allows kitchen utensils to be easily stored and removed.

It is an object of the present invention to provide a kitchen utensil organizer that is compact and easily accessible.

It is an object of the present invention to provide a lazy-susan type of kitchen utensil organizer.

It is an object of the present invention to provide a kitchen utensil stand with rotating storage hooks for hanging kitchen utensils thereon.

It is an object of the present invention to provide a rotating utensil storage stand with a drip surface under said stored utensils.

It is a further object of the present invention to provide a utensil storage stand that will store at least 20 utensils at one time.

It is a further object of the present invention to provide a storage stand having open rings and hooks for easy and convenient access and storage.

It is a further object of the invention to provide a utensil storage stand where utensils may be stored in a pre-arranged rotational sequence as called for in following a recipe.

### DETAILED DESCRIPTION OF THE DRAWINGS

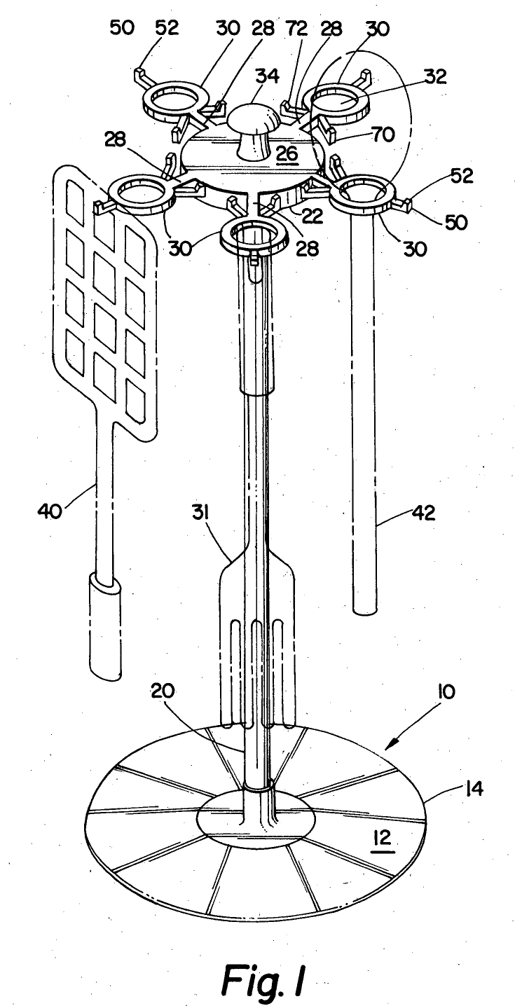

What is shown in FIG. 1 is the utensil storage stand 10 having a support base shown at 12 with an outer perimeter 14 on the support base 12. The support base 12 joins a column 20 that arises and extends away from the support base 12 until it comes to an upper utensil engagement means 22. The upper utensil engagement means 22 is rotatable with respect to the base 12 and has means 24 on the column for allowing rotation of the utensil means 22. The utensil means 22 comprises a disc 26 having spokes 28 immediately extending from the disc 26 and having ring means 30 on the spokes 28 with each ring means 30 having a perforation 32 formed there through so that the handle of the utensil means 31 may extend through the perforation 32 and towards the support base 12. The upper knob 34 is shown so that a person may use their fingers to rotate the upper utensil engage means 22 with respect to the base 12. Utensils such as 40 and 31 are shown thereon engaged with the utensil engagement means 22. On the outer perimeter of the rings 30 are the upwardly facing hooks 50 shown protruding from the periphery of the rings 50 with upwardly extending sections 52 thereon forming an upwardly facing hook on the utensil engagement means 22. Inwardly of the ring 30 on the spokes 28 are two upwardly facing hooks 70 and 72 which preferably form an acute angle with the longitudinal axis of the spokes 28 of approximately 56 degrees. The acute angle of 56 degrees allows utensils to be hung so as to have easy access on the stand and provide more space for storage. The preferable arrangement is that there will be five spokes 28 on the disc means 26 and each perforated ring will have three upwardly facing hooks on said arrangement.

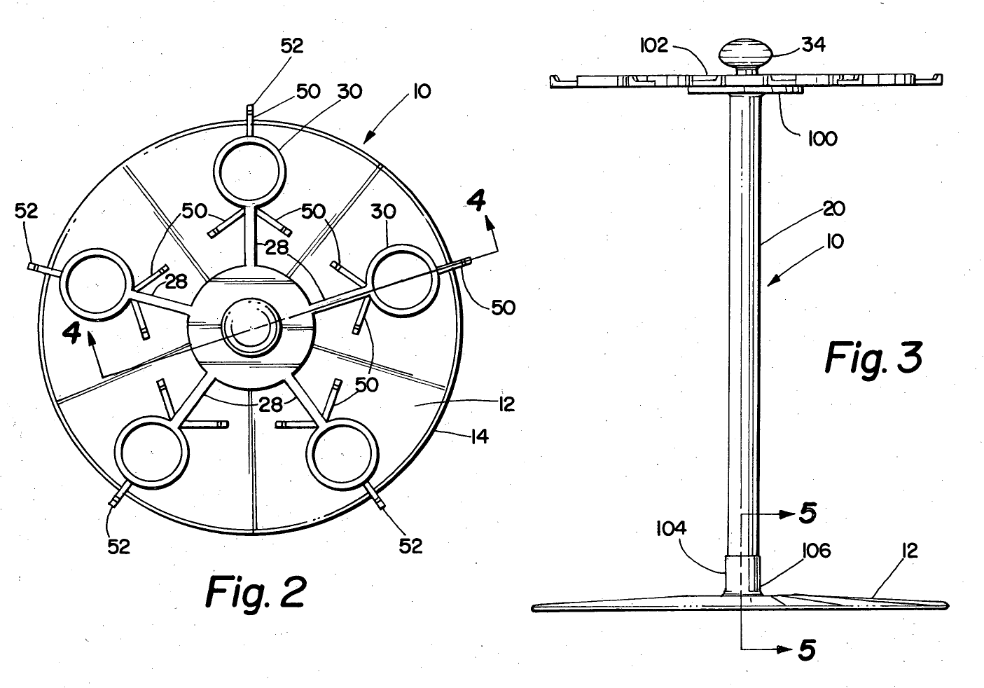

What is shown in FIG. 2 is a top view of the utensil storage stand according to the present invention. Shown is the support base 12 and the outer periphery 14 of the support base 12 which forms the drip surface. The disc 26 is shown with the radially extending spokes 28 having the rings 30 formed on the outer ends of the spokes 28. It is preferable that the individual rings 30 have three hooks 50 and hook ends 52 formed thereon. Two of the hooks will form the acute angle as shown with the preferred acute angle being 56 degrees.

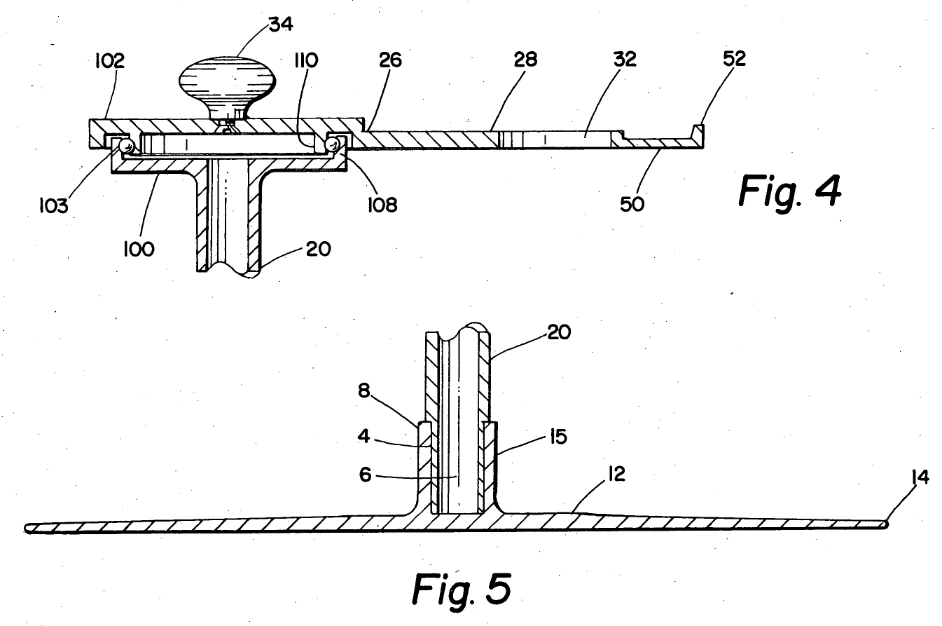

What is shown in FIG. 3 is a side view of the utensil support stand, 10 having the support base 12, the column 20 and the upper disc 26. The upper disc 26 has co-operative elements of rotatable engagement with the column 20, as is shown at 100 and 102. Further detail of this arrangement is shown in FIG. 4, which is a cross sectional view 44 through FIG. 2. In addition co-operative elements of rotatable engagement between the column 20 and the base 12 are shown at 104 and 106. Further details of this arrangement are shown in FIG. 5 which is a cross-sectional view through 5-5 of FIG. 3.

What is shown in FIG. 4 is a cross sectional view of the co-operative elements of rotatable engagement 100 and 102 between the column 20 and the disc 26 of the utensil support stand 10 according to the present invention. Ball bearings 103 are shown interposed between the elements 100 and 102 and held in place between lips 108 on the element 100 and lip 110 on the element 102. The spaced distance between the lips confine the ball bearings and allow the two separate elements 100 and 102 to rotate with respect to one another. The perforation 32 is shown in the spoke 28 along with the outer hook 50 which forms the terminal end of the spoke 28.

What is shown in FIG. 5 is the co-operating elements of rotatable engagement between the support base 12 and the column 20 of the support stand 10 according to the present invention. Shown in FIG. 5 is a cross-sectional view 5-5 through FIG. 3 of the utensil support stand 10 according to the present invention. FIG. 5 shows the support base 12 having the outer periphery 14. The column 20 joins with the support base 12 at support base post 15. The support base post 15 is located in the center of the support base 12 and forms a boss 8 with a hollow center 6 for telescopically engaging the lower portion of the column 20.

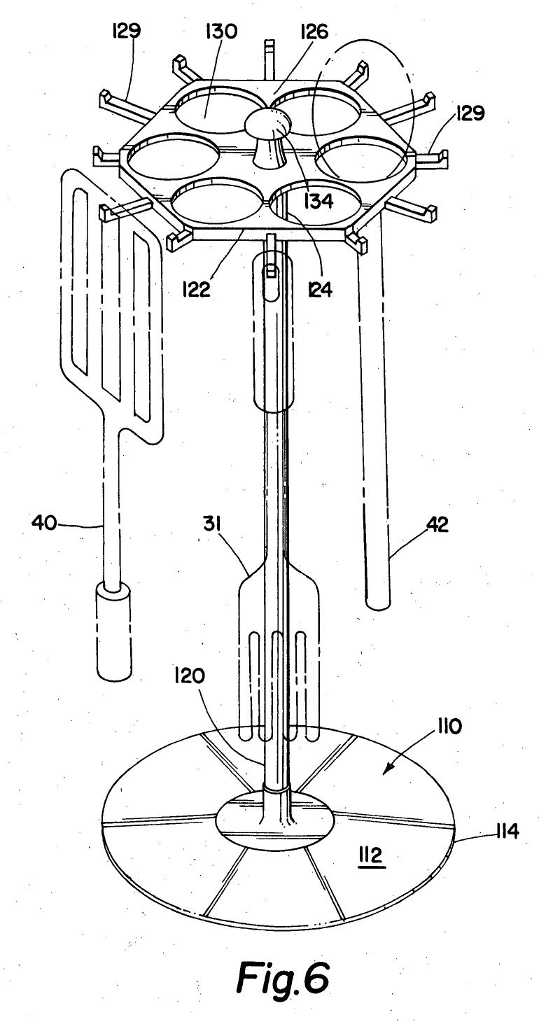

What is shown in FIG. 6 is an alternate embodiment of the utensil stand holder according to the present invention. Shown in FIG. 6 is the utensil storage stand 110 having a support base shown at 112 with an outer perimeter 114 on the support base 112. The support base 112 has a column 120 that arises and extends away from the support base 112 until it comes to an upper utensil engagement means 122. The upper utensil engagement means 122 is rotatable with respect to the base 112 and has means 124 on the column 120 for allowing rotation of the utensil means 122. The utensil means 122 comprises a disc 126 having hooks 129 immediately extending from the disc 126. Perforations 130 formed in the disc 126 so that a handle of the utensil 42 may extend through the perforation 130 and towards the support base 112. The upper knob 134 is approximately One inch high so that a person may use their fingers to rotate the upper utensil engage means 122 with respect to the base 112. Utensils such as 40 and 42 are shown thereon engaged with the utensil engagement means 122. On the outer perimeter of the rings 30 are the hooks 50 shown protruding from the periphery of the rings 30 with upwardly extending sections 52 thereon forming an upwardly facing hook on the utensil engagement means 22. Inwardly of the ring 30 on the spokes 28 are two upwardly facing hooks 70 and 72, which form an acute inward angle of approximately 56 degrees with the spokes 28. The acute angle of 56 degrees allows utensils to be hung so as to have easy access on the stand and provide more space for storage. The preferable arrangement is that there will be five spokes 28 on the disc means 26 and each perforated ring will have three upwardly facing hooks on said arrangement.

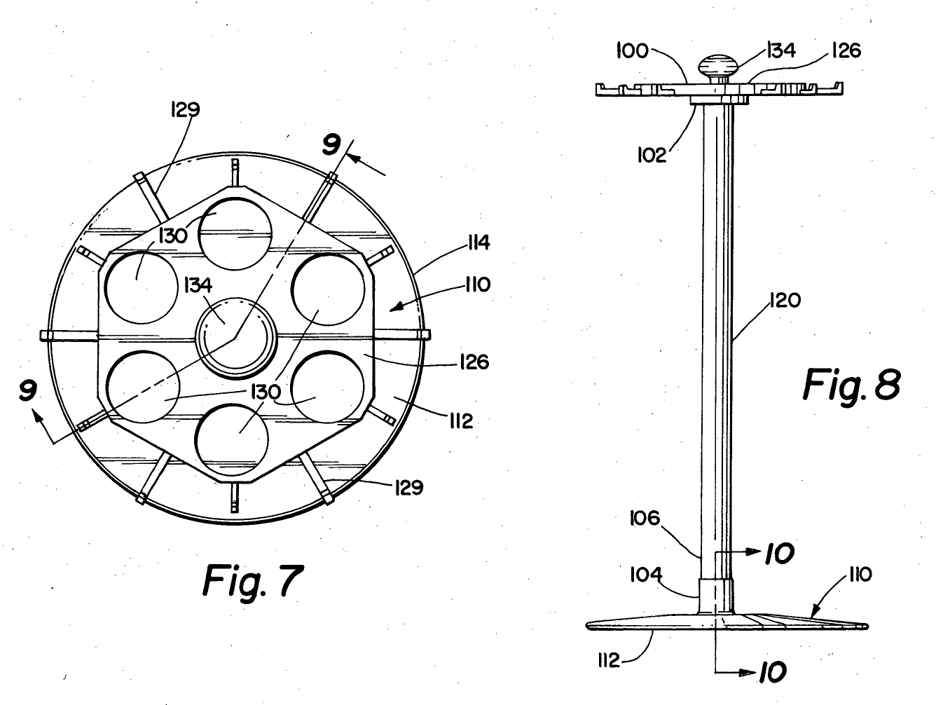

What is shown in FIG. 7 is a top view of the alternate utensil storage stand 110 according to the present invention. Shown is the support base 112 and the outer periphery 114 of the support base 112. The disc 126 is shown with the radially extending spokes 129 having the perforations 130 formed therein.

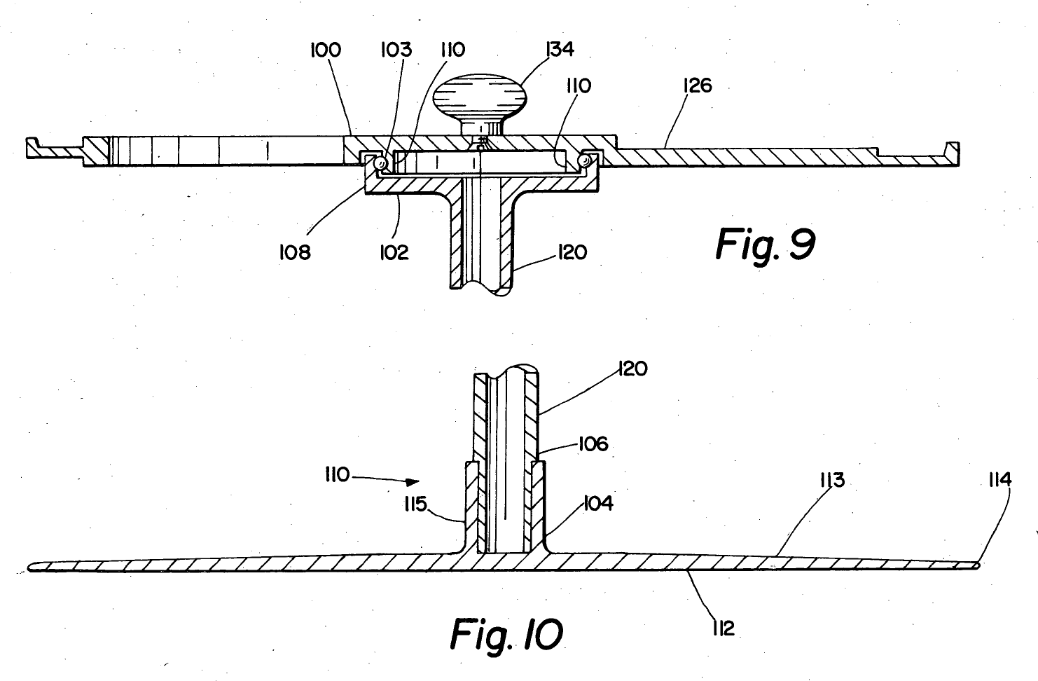

What is shown in FIG. 8 is a side view of the alternate embodiment of the utensil support stand 110 according to the present invention. The utensil support stand 110 is shown having a support base 112, a column 120 and the upper disc 126. The upper disc 126 has co-operative elements of rotatable engagement with the column 120, as is shown at 100 and 102. Further detail of this arrangement is shown in FIG. 9, which is a cross sectional view 9-9 through FIG. 7. In addition co-operative elements of rotatable engagement between the column 120 and the base 112 are shown at 104 and 106. Further details of this arrangement are shown in FIG. 10, which is a cross-sectional view through 10-10 of FIG. 8.

What is shown in FIG. 9 is a cross sectional view 9-9 through section 9-9 of FIG. 7 of the alternate embodiment according to the present invention. FIG. 9 shows the arrangement of the co-operative elements of rotatable engagement 100 and 102 between the column 120 and the disc 126 of the utensil support stand 110 according to the present invention. Ball bearings 103 are shown interposed between the elements 100 and 102 and held in place between lips 108 on the element 100 and lip 110 on the element 102. The spaced distance between the lips confine the ball bearings and allow the two separate elements 100 and 102 to rotate with respect to one another. The perforation 32 is shown in the spoke 28 along with the outer hook 50 which forms the terminal end of the spoke 28.

What is shown in FIG. 10 is a cross-sectional view 10-10- shown at sections 10-10 in FIG. 7 of the alternate embodiment of the utensil support stand according to the present invention. Shown in FIG. 10 are the co-operating elements of rotatable engagement between the support base 112 and the column 120 of the support stand 110 according to the present invention. FIG. 10 shows the support base 112 having the outer periphery 114. The support base 112 has a tapering surface that extends out to the periphery 114 that forms a drip surface around the column 120 that extends between the support base 112 and the disc with spokes 126 and 129. The column 120 joins with the support base 112 at support base post 115. The support base post 115 is located in the center of the support base 112 and forms a boss with a hollow center for telescopically engaging the lower portion of the column 20. The telescopically engaged portions are preferably cemented so that they are non-rotatable with one another when the utensil stand utilizes an arrangement wherein the column and the upper utensil support means are rotatable with respect to one another.

In the preferred embodiment of the invention the base will be approximately ⅛ inch in the middle and tapering as it extends outwardly to about 1/16 or less inch thick at the outer perimeter of the base. The column will be approximately ¾ inch in diameter and about 14 inches high. At the top of the post will be a disc three inches in diameter and ½ inch thick and will have 5 equally spaced ¼ inch square spokes extending out from its periphery.

We claim:

1. The utensil storage stand which comprises:
a. a support base;
b. a central column extending away from said support base;
c. utensil engagement means located on said column a spaced distance from said support base;
d. means for rotating said utensil engagement means in relation to said support base.

2. The utensil storage stand according to claim 1, in which said utensil engagement means comprises radial spokes extending away from said column with utility engagement means on said spokes.

3. The utensil storage stand according to claim 2 in which said utensil engagement means comprises at least one of said spokes having a radially outwardly placed perforation allowing a utensil handle to pass through said perforation and extend toward said base.

4. The utensil storage stand according to claim 2 in which said utensil engagement means comprises hook means on the outer periphery of said perforation.

5. The utensil storage stand according to claim 4 which further comprises hook means on said spokes and located between said column and said perforation.

6. The utensil storage stand according to claim 5 in which said hook means on said spokes form an acute angle of 56 degrees plus or minus 5 degrees with the axis of said spoke.

7. The utensil storage stand according to claim 2 which further comprises a disk formed at the upper portion of said column and said spokes radially extending from the outer periphery of said disk.

8. The utensil holding stand according to claim 7 in which said utensil engagement means comprises a polygonal disc with perforations therein for allowing utensil handles to pass through and extend toward the support base.

9. The utensil holding stand according to claim 8 which further comprises upwardly facing hooks located on the outer periphery of said polygonal disc.

10. The utensil storage stand according to claim 1 in which said means for rotating said utensil engagement means in relation to said support base comprises co-operating elements of ball bearing means connecting between said column column and one of said utensil engagement means and said support base.

11. The utensil storage stand according to claim 1 which further comprises said column and said support base having co-operative elements of telescopic engagement with one another.

12. The utensil storage stand according to claim 10 which further comprises said column and said support base having co-operating elements of telescopic engagement with one another.

13. The utensil storage stand according to claim 10, in which said utensil engagement means comprises radial spokes extending away from said column with utility engagement means on said spokes.

14. The utensil storage stand according to claim 13 in which said utensil engagement means comprises at least one of said spokes having a radially outwardly placed perforation allowing a utensil handle to pass through said perforation and extend toward said base.

15. The utensil storage stand according to claim 14 in which said utensil engagement means comprises hook means on the outer periphery of said perforation.

16. The utensil storage stand according to claim 15 which further comprises hook means on said spokes and located between said column and said perforation.

17. The utensil storage stand according to claim 16 in which said hook means on said spokes form an acute angle of 56 degrees plus or minus 5 degrees with the axis of said spoke.

18. The utensil storage stand according to claim 17 which further comprises a disk formed at the upper portion of said column and said spokes radially extending from the outer periphery of said disk.

19. The utensil holding stand according to claim 18 in which said utensil engagement means comprises a polygonal disc with perforations therein for allowing utensil handles to pass through and extend toward the support base.

20. The utensil holding stand according to claim 19 which further comprises upwardly facing hooks located on the outer periphery of said polygonal disc.
